(19) United States
(12) Patent Application Publication
(10) Pub. No.: US 2026/0098504 A1
(43) Pub. Date: Apr. 9, 2026

(54) SYSTEM FOR ACCUMULATING AND COMPENSATING FOR FUEL INJECTOR WEAR

(71) Applicant: Caterpillar Inc., Peoria, IL (US)

(72) Inventors: Ryan M. Hinrichsen, Groveland, IL (US); Daniel Reese Puckett, Peoria, IL (US); Gregory Lance Armstrong, Edwards, IL (US); Michael E. Sattler, Eureka, IL (US)

(73) Assignee: Caterpillar Inc., Peoria, IL (US)

(21) Appl. No.: 18/908,698

(22) Filed: Oct. 7, 2024

(51) Int. Cl. F02D 41/30; F02D 41/22

(52) U.S. Cl. CPC F02D 41/3005; F02D 41/22; F02D 2041/224; F02D 2250/12

(57) ABSTRACT

A combustion engine system may include a combustion engine having a cylinder and a fuel injection system. The fuel injection system may include a common rail containing pressurized fuel and a fuel injector in fluid communication with the common rail and the cylinder, or other cylinder access pathway. The system may also include an electronic control module in signal communication with the fuel injector for controlling opening and closing of the fuel injector, where opening the fuel injector may include holding the fuel injector open for a particular amount of time. The electronic control module may be configured for accumulating wear on the fuel injector as accumulated wear, determining the particular amount of time as a compensation time to compensate for the accumulated wear, and operating the fuel injector by opening the fuel injector for the compensation time.

### TECHNICAL FIELD

The present application relates generally to combustion engine performance. More particularly, the present application relates to a fuel injection system of a combustion engine. Still more particularly, the present application relates to systems and methods relating to wear of fuel injectors within the fuel injection system.

### BACKGROUND

Combustion engines may include a fuel injection system. The fuel injection system may rely on fuel injectors for administering suitable amounts of fuel to the combustion chambers of the engine. Over time and through use, the fuel injectors may experience wear, which can cause them to inject excess, or insufficient, amounts of fuel for combustion. This can result in the engine power unintentionally growing or reducing over time, which can affect fuel efficiency as well as emissions of the engine.

Chinese Patent Application No. 114370346 relates to an engine parameter correction method and Japanese Patent Application 3,982,516 relates to a fuel injection device for an internal combustion engine.

### SUMMARY

In one or more examples, a combustion engine system may include a combustion engine having a cylinder and a fuel injection system. The fuel injection system may include a common rail containing pressurized fuel and a fuel injector in fluid communication with the common rail and the cylinder, or other cylinder access pathway. Opening and closing the fuel injector may place the common rail in fluid communication with the cylinder, or other cylinder access pathway. The system may also include an electronic control module in signal communication with the fuel injector for controlling opening and closing of the fuel injector, where opening the fuel injector may include holding the fuel injector open for a particular amount of time. The electronic control module may be configured for accumulating wear on the fuel injector as accumulated wear, determining the particular amount of time as a compensation time to compensate for the accumulated wear, and operating the fuel injector by opening the fuel injector for the compensation time.

In one or more other examples, a method for compensating for fuel injector wear may include accumulating wear on the fuel injector as accumulated wear. The method may also include determining a compensation time to hold a fuel injector open to compensate for the accumulated wear. The method may also include operating the fuel injector by opening the fuel injector for the compensation time.

### BRIEF DESCRIPTION OF THE DRAWINGS

FIG. 1 is a perspective view of a combustion engine, according to one or more examples.

FIG. 2 is a cross-section view of several cylinders of the combustion engine of FIG. 1, according to one or more examples.

FIG. 3 is a schematic diagram of a fuel supply system of the combustion engine of FIG. 1, according to one or more examples.

FIG. 4 is a schematic diagram depicting a method for accumulating and compensating for fuel injector wear, according to one or more examples.

FIG. 5 is a diagram depicting an example of calculations associated with the method of FIG. 4.

FIG. 6 is an example of a wear factor damage map used in the method of FIG. 4, according to one or more examples.

FIG. 7 is an example graph depicting wear units versus wear parameters, according to one or more examples.

FIG. 8 is an example graph depicting fuel injector duration versus delivery amount, according to one or more examples.

FIG. 9 is a block diagram depicting the steps of the method shown schematically in FIG. 4.

### DETAILED DESCRIPTION

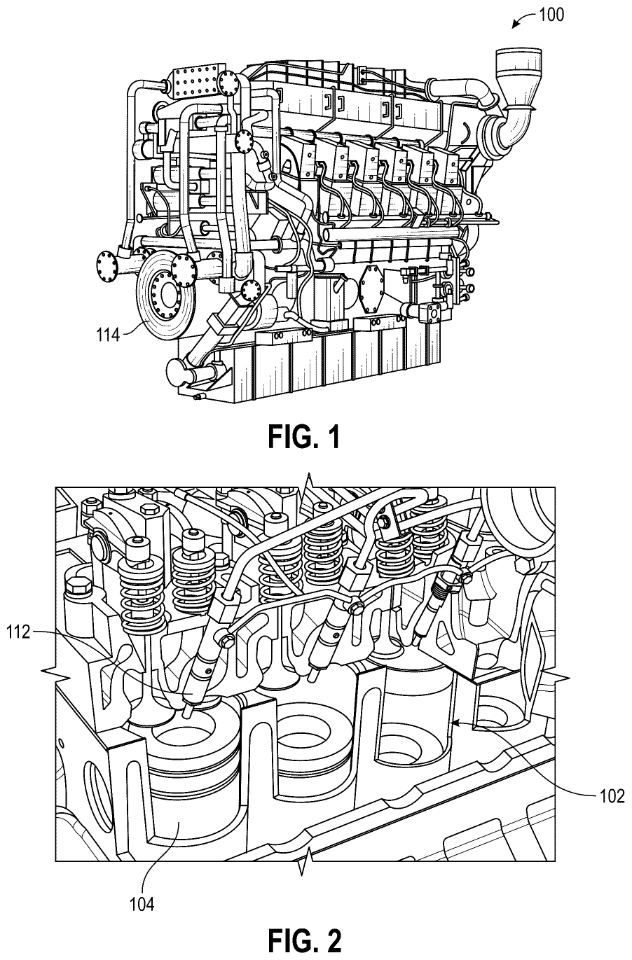

FIG. 1 is a perspective view of a combustion engine 100. As shown in FIG. 2, the combustion engine 100 may include one or more cylinders 102 with reciprocating pistons 104 arranged therein. The pistons 104 may be connected to a crank shaft via one or more rods. As discussed in more detail below, the engine 100 may include a fuel manifold or rail 106 that receives fuel from a fuel tank 108 via a fuel pump 110, for example. The fuel manifold or rail 106 may be arranged and configured to deliver fuel to the cylinders 102 via one or more fuel injectors 112. The engine 100 may also include an air system that receives air from outside of the engine, delivers air to the cylinders 102 for combustion, treats the air, and exhausts the air back into the environment. The combustion engine 100 may also include an ignition system for delivering a spark to the cylinders 102 to burn the fuel/air mixture received from the fuel manifold or rail 106 and the air system, which may drive the pistons 104 to turn the crank shaft and generate rotational power. In one or more examples, the engine 100 may include a power takeoff or fly wheel 114 for coupling to equipment to be mechanically powered. In one or more examples, the equipment to be powered may include waterborne vessels, electrical generators, heavy equipment or work machines, or other systems.

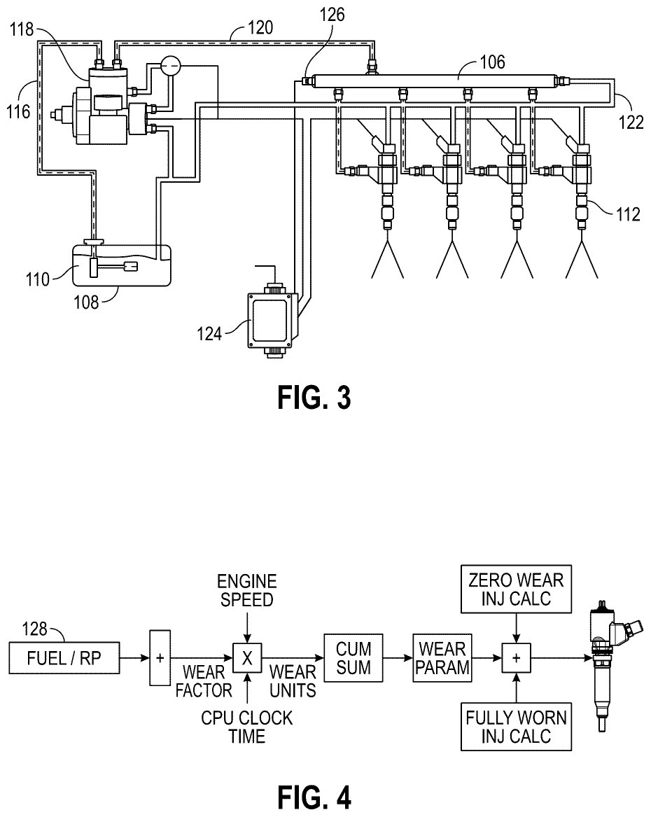

Referring now to FIG. 3, a schematic diagram of the fuel delivery system is shown. As alluded to above, the fuel delivery system may be configured to deliver fuel to the cylinders 102 and it may do so in a controlled manner. That is, particular amounts of fuel may be delivered to the cylinders 102 at particular times to control the power output of the engine, to manage fuel efficiency, and to manage emissions. Where insufficient fuel is provided, the powered equipment may receive insufficient power resulting in under-performance and where too much fuel is provided, the powered equipment may be overpowered resulting in wasted energy and/or fuel consumption. The fuel delivery system may include a fuel tank 108 with a fuel pump 110 arranged therein. The fuel delivery system may also include a fuel supply line 116 leading from the fuel pump 110 to a high-pressure pump 118 and an additional fuel supply line 120 leading from the high-pressure pump 118 to a common rail 106. Still further fuel lines 122 may lead back to the fuel tank 108 from the common rail 106 via a pressure limiting valve. The common rail 106 may be in fluid communication with one or more fuel injectors 112.

The fuel injectors 112 may be in fluid communication with the common rail 106 to receive high-pressure fluid. The fuel injectors 112 may also be in fluid communication with the cylinders 102 or other cylinder access pathway and may function to open/close to allow the high-pressure fluid from the common rail 106 to enter the cylinder 102 for combustion. For purposes of actuation, the fuel injectors 112 may be in electrical communication with an electronic control module or unit 124. In one or more examples, the electronic control module 124 may be a dedicated module for operation of the combustion engine 100 or an electronic control module of the associated powered equipment may be used. In either case, the electronic control module 124 may be configured to send signals to the one or more fuel injectors 112 to open the injectors to allow for the injection of fuel. That is, the fuel injectors 112 may be biased in a closed position and signals from the electronic control module 124 may function to hold the fuel injectors 112 open for a particular amount of time, creating a pathway from the common rail 106 to the cylinders 102, and delivering a particular amount of fluid. In one or more examples, the electronic signal from the electronic control module 124 may trigger a solenoid that has sufficient power to overcome the force biasing the fuel injector 112 closed. The rate of fuel passing through the fuel injector 112 may depend on the amount of pressure in the common rail 106 and the flow area created by opening the fuel injector 112. With the given rate of fuel flow, the fuel injector 112 may be held open for a particular amount of time to deliver a particular amount of fluid.

The fuel injector 112 may include an internal bore including a needle valve with a conical tip that engages a generally conical seat to close off flow through the injector. As mentioned, the needle may be biased in a closed position by a biasing mechanism such as, for example, a spring. The electronic solenoid may be configured to generate a force on the needle to overcome the spring force. Each time the solenoid is actuated the needle may be lifted from the seat and when the solenoid is deactivated, the needle tip may forcibly reengage the seat. This repetitive process may cause deformation and/or plastic deformation of the seat, the needle tip, or both, which may change the shape, size, or area of the engagement between the tip and the seat. For example, as the needle tip drives into the seat, and where the needle tip is harder than the seat, the repetitive engagement may function to open the conical shape of the seat lessening the area of contact of the needle tip and the seat. (i.e., contact may be more limited to broader portion of the needle tip and less contact may occur near the narrower portion of the needle tip). Still other types of deformation including deformations that increase the contact area may also occur. Still further, wear may occur due to fluid flowing through the injector at a high pressure. That is, while the contact between the needle and the seat have been discussed, the flow of high-pressure fluid through the injector may result in deformations or erosions within the injectors as well.

To address this wear, the electronic control module 124 may be configured to adjust the amount of time the injectors are open so as to compensate for the wear and maintain a more consistent fuel delivery amount over time. In one or more examples, the electronic control module 124 may include software, hardware, or a combination of software and hardware configured to accumulate wear and adjust the amount of fuel delivery based on the accumulated wear. That is, the electronic control module may include a computer readable storage medium, a processor, one or more inputs, and one or more outputs. The computer-readable storage medium may include computer-implemented instructions stored thereon for performing a method of accumulating wear and adjusting fuel delivery. Alternatively or additionally, the processor may include hardware (i.e., computer chips or other hardware) that are configured to perform the method or a portion thereof. As discussed in more detail below, the method may include monitoring and accumulating the amount of wear of the fuel injectors and adjusting the delivery of fuel to the cylinders to compensate for the amount of wear that has occurred.

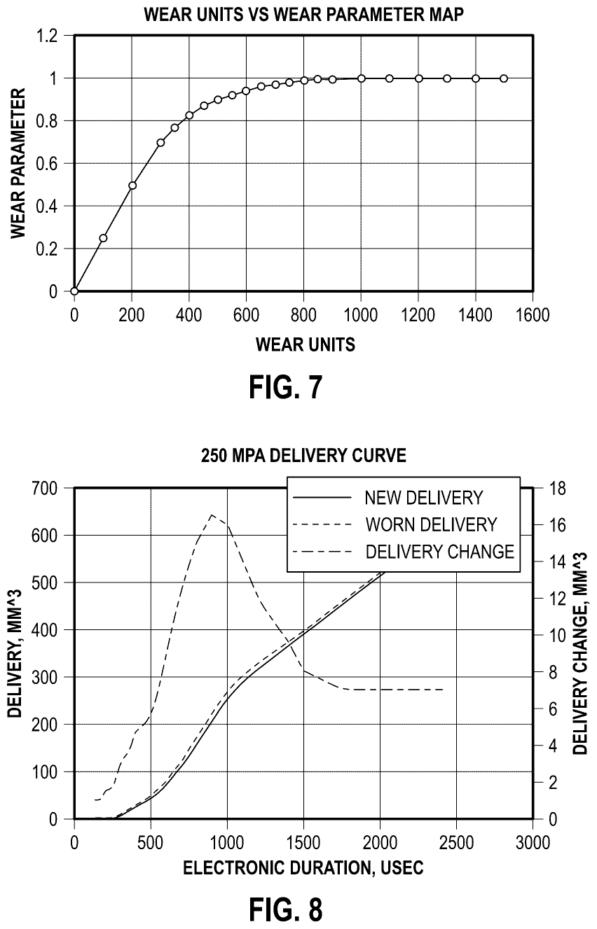

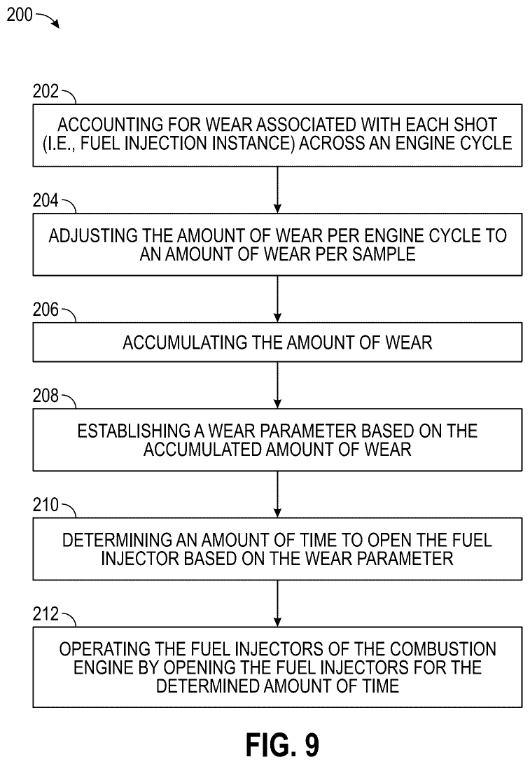

For purposes of accumulating wear and adjusting the delivery of fuel, the electronic control module 124 may include one or more charts, graphs, tables, maps, or other reference tools that may be used by the electronic control module 124 to accumulate, and adjust for, wear. In one or more examples, these tools may be stored in the computer readable storage medium of the electronic control module 124. In one or more examples, the reference tools may include one or more wear factor damage maps such as the map shown in FIG. 4. In addition, the reference tools may include one or more wear parameter maps such as those shown in FIG. 7. Still further, the reference tools may include one or more fuel delivery curves as well as a change in fuel delivery curve as shown in FIG. 8. Still other reference tools may be provided for use by the electronic control module 124 to accumulate, and adjust for, wear.

For purposes of monitoring and accumulating wear, the electronic control module 124 may be in communication with one or more sensors. For example, the number of “shots” of fuel may be monitored with respect to a number of engine cycles and, as such, an engine monitor configured for identifying the revolutions per minute (RPMs) of the engine may be provided. This monitor may be a physical monitor that monitors revolutions of the crankshaft, for example. Alternatively or additionally, a computer monitor may be provided that uses the electronic timing within the electronic control module 124 that is associated with operating the engine to capture the revolutions per minute (RPMs). Moreover, the amount of wear on the fuel injectors 112 may depend on the pressure under which they are operating. Accordingly, the system may include one or more pressure sensors 126 arranged and configured to sense the pressure in the common rail or rails 106. Still other sensors may be provided and may be in communication with the electronic control module 124 to allow the electronic control module 124 to manage the engine operation.

### INDUSTRIAL APPLICABILITY

In operation and use, the above-mentioned process 200 may be used to accumulate wear of fuel injectors 112 and adjust the operation of the fuel injectors 112 to compensate for the wear so that a more consistent amount of fuel may be delivered to the cylinders 102 of the engine 100. In one or more examples, the method may include accounting (202) for wear associated with each shot (i.e., fuel injection instance) across an engine cycle. The method may also include adjusting (204) the amount of wear per engine cycle to an amount of wear per sample and accumulating (206) the amount of wear. The method may also include establishing (208) a wear parameter based on the accumulated amount of wear. The method may also include determining (210) an amount of time to open the fuel injector based on the wear parameter. The method may also include operating (212) the fuel injectors of the combustion engine by opening the fuel injectors for the determined amount of time. Each of these steps are discussed in more detail below.

With respect to accounting (202) for wear associated with each shot across an engine cycle, one or more shots may be provided during the course of an engine cycle. That is, while a main injection or shot 128 may provide the fuel for combustion and power as shown in FIG. 4, several other injections or shots may occur throughout the process of cycling the engine. In one or more examples, a pilot injection or shot may be provided. The pilot injection or shot may occur just after the piston reaches a bottom dead center position and begins to travel upward within the cylinder. In addition, a pre-injection or shot may occur in an effort to reduce or minimize the ignition delay for the main injection. Still further, an after injection may be provided to assist with combustion of particulate matter that was not combusted during the main shot. A post injection or shot may also be provided that can assist with regeneration of, for example, a diesel particulate filter arranged in the air system downstream of the engine. Some or all of these shots may be provided and still other shots may be provided depending on the design of the fuel delivery system.

The above-mentioned injections or shots may be performed for a particular amount of time and at a particular amount of pressure (i.e., the common rail pressure) resulting in a particular volume of fluid flowing through the injector. However, and while the rail pressure may be consistent across a series of shots, the amount of time each shot is performed may vary depending on the type of shot. Moreover, rail pressure could also fluctuate or change. In view of this, the method may be configured to capture an amount of wear associated with each type of shot based on the pressure at the time of the shot as well as the amount of fluid that flows through the injector during that shot.

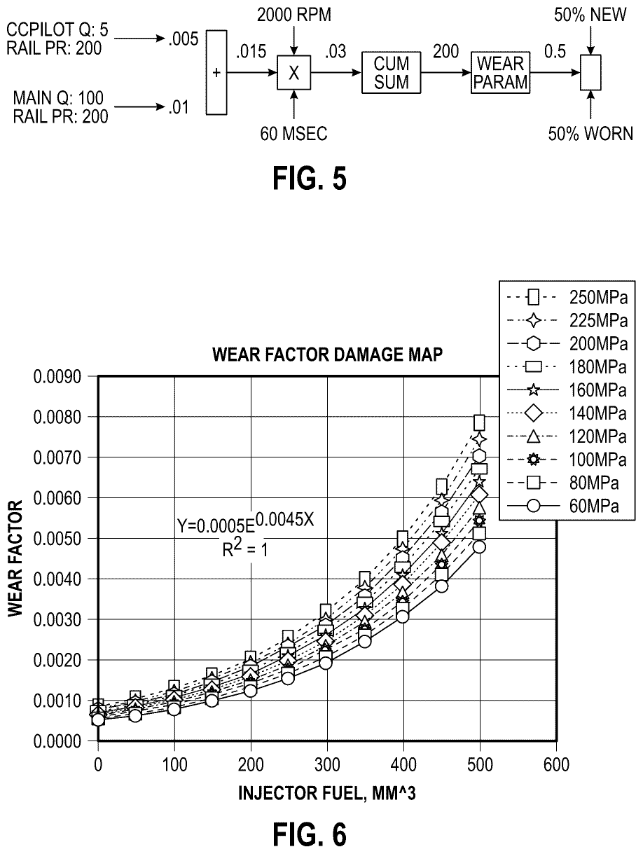

FIG. 6 is an example of a wear factor damage map. The map may be developed for a particular type of injector based on testing. As shown, the present map includes pressure curves that relate volumes of fluid passing through the injector to wear factors. That is, at a particular pressure, given a particular amount of fluid, a wear factor may be determined or calculated. It is to be appreciated that while the present damage map is focused on volume of fluid flow through the injector, other maps may be more focused on pressure and a number of times the valve opens and closes. Still other relationships between the operating conditions and the amount of incremental wear caused may be provided. Nonetheless, and in view of the above, each shot for a given engine cycle may occur at a particular pressure and may deliver a particular volume of fluid to the cylinders. A wear factor may, thus, be established for each shot based on the wear factor damage map. The amount of wear (e.g., wear unit) for a single engine cycle may, thus, be established by adding the wear factors associated with each shot of the engine cycle together. In the example of FIG. 5, a pilot shot having a rail pressure of 200 MPa and a fluid volume of 5 mm³ may have a wear factor of 0.005 and a main shot having a rail pressure of 200 MPa and a fluid volume of 100 mm³ may have a wear factor of 0.01. The wear unit or total amount of wear per cycle may, thus, be 0.015.

With respect to adjusting (204) the amount of wear per engine cycle to an amount of wear per sample, the total of the wear factors for each cycle may be adjusted to account for sample timing. That is, rather than capture the pressure and flow volume from each shot every time the engine cycles, a sample rate may be selected that is irrespective of engine speed. The sample rate may have relatively short intervals such that the engine operation between samples may not change or, if it does change, it may change an insubstantial amount. In one or more examples, a sample rate may range from 10 milliseconds to 120 milliseconds, or from 40 milliseconds to 80 milliseconds, or a sample rate of 60 milliseconds may be used. Still other sample rates within or outside the ranges identified may be used. Since, in this approach, the sample rate is irrespective of engine speed, the amount of wear per engine cycle can be adjusted based on engine speed as shown in the example of FIG. 5. That is, where the engine is operating at 2000 revolutions per minute (RPM) and the sample rate is 60 milliseconds, a multiplier of 2 may be used to calculate the amount of wear since the previous sample. (i.e., 2000 RPM/60 seconds per minute×0.06 seconds=2). Having calculated the amount of wear per sample, accumulating (206) the amount of wear experienced by the fuel injectors may include adding the newly sampled amount of wear to previously accumulated amounts of wear to determine accumulated wear. That is, the system may continually add newly captured amounts of wear from each sample and may maintain an accumulated wear on the fuel injectors.

It is to be appreciated that while the present method has been described as taking samples at a selected sample rate, samples may also be taken each time the engine cycles or at particular intervals of engine cycles. That is, the sample rate may fluctuate based on the engine speed and may capture wear amounts at each cycle of the engine or at intervals of engine cycles (i.e., every other cycle or every 3^{rd}, 4^{th}, or 5^{th} cycle). In these cases, the captured amounts of wear (i.e., wear units) may be adjusted to account for the interval number. That is, where the wear is being captured at every engine cycle, no adjustment would be performed, but if the wear is being captured every other engine cycle, the captured values would be doubled to account for the skipped cycle. Still other methods of capturing and adjusting the amounts of wear may be provided.

The system may also establish (208) a wear parameter based on the accumulated wear. For example, wear parameter maps may be created for particular fuel injectors based on testing. The testing may reveal how the fuel injector performs as it wears over particular amounts of use. As shown in FIG. 7, a fuel injector may wear in a generally linear fashion for over a period of use (i.e., 0-325 wear units) after which it may wear more slowly until it reaches a relatively fully worn out condition at approximately 1000 wear units and after which it exhibits little to no further wear. Depending on the nature of the fuel injector, other wear parameter curves may be established through testing and may be based on the particular wear characteristics of a particular fuel injector. For example, while the present wear parameter map has a relatively steep slope that gives way to a generally horizontal line, other curves may start out with a relatively shallow slope (e.g., high resistance to wear at first), which may give way to a steeper slope (e.g., initial wear resistance overcome and beginning to wear), which may give way to a horizontal line (e.g., more fully worn out with little further wear to occur). Still other curve types may be established through testing of fuel injectors. In any case, given the known wear parameters of a particular fuel injector, a map with a parameter curve such as that of FIG. 7 may be used to establish a wear parameter by using the accumulated wear from the accumulating (206) step to establish the wear parameter. For example, as shown in FIG. 5, a total amount of wear of 200 may allow for establishing a wear parameter of 0.5. In one or more examples, this wear parameter may be considered to reflect the percentage of wear between new and fully worn that the fuel injector has experienced.

This information may be used to operate the engine to account for accumulated wear. That is, the method may include determining (210) an amount of time to open the fuel injector based on the wear parameter. Here, the system may rely on fuel delivery curves for the particular fuel injectors. That is, for example, FIG. 8 shows the relationship between the amount of time a fuel injector is open (bottom horizontal axis) and the amount of fuel that is delivered (left vertical axis) for a particular common rail pressure of 250 MPa. Moreover, two curves are provided. A first curve is based on a new injector and a second curve is based on a fully worn injector. Still another curve, which is provided for reference, shows the change in the fuel delivery amount (right vertical axis) between the two curves at particular amounts of time that the fuel injectors are open (bottom horizontal axis). To determine the amount of time to open the fuel injector at a particular rail pressure, the system may access a map corresponding to that particular pressure and may receive a fuel demand volume based on the operating needs of the engine. The system may then use the wear parameter together with the first new injector curve and the second worn injector curve to determine how long to hold the injector open. For example, as shown in FIG. 5, with a wear parameter of 0.5, the method may use the summation of 50% of the new curve value and 50% of the worn curve value to determine how long to hold the injector open for a particular fuel demand. In another example, where the wear parameter may be 0.8, the method may rely on 80% of the worn curve and 20% of the new curve for a particular fuel demand.

In this manner, the fuel injectors of the engine may be operated (212) to compensate for the accumulated wear they have experienced. That is, the electronic control module controlling the combustion engine may signal the solenoids or other actuators of the fuel injectors to hold the fuel injectors open for the determined amount of time based on particular fuel demands. It is to be appreciated that the “open time” for each of the several shots performed throughout the engine cycle may be adjusted to compensate for wear based on the method described and based on the particular fuel demands of each shot. This may allow for more appropriate amounts of fuel to be delivered to the engine over time and may avoid supplying too much fuel or supplying insufficient amounts of fuel due to injector wear.

It is to be appreciated that while the map of FIG. 8 generally shows that a worn fuel injector supplies more fuel than a new injector, the opposite may also be true, where a worn fuel injector supplies less fuel than a new injector. The method accommodates both situations by using a wear parameter to adjust the length of time to open the fuel injector based on both the new and worn curves.

The above detailed description is intended to be illustrative, and not restrictive. The scope of the disclosure should, therefore, be determined with references to the appended claims, along with the full scope of equivalents to which such claims are entitled.

1. A combustion engine system, comprising:
a combustion engine having a cylinder,
a fuel injection system, comprising:
a common rail containing pressurized fuel;
a fuel injector in fluid communication with the common rail and the cylinder or other cylinder access pathway, wherein opening and closing the fuel injector places the common rail in fluid communication with the cylinder or other cylinder access pathway;
an electronic control module in signal communication with the fuel injector for controlling opening and closing of the fuel injector, wherein opening the fuel injector comprises holding the fuel injector open for a particular amount of time and the electronic control module is configured for:
accumulating wear on the fuel injector as accumulated wear,
establishing a wear parameter based on the accumulated wear;
determining the particular amount of time as a compensation time to compensate for the accumulated wear by:
using a new fuel injector delivery curve to determine a first delivery time:
using a worn fuel injector delivery curve to determine a second delivery time; and
using the wear parameter to adjust the first delivery time and the second delivery time to arrive at the compensation time; and
operating the fuel injector by opening the fuel injector for the compensation time.

2. The combustion engine system of claim 1, wherein the electronic control module is further configured for accounting for wear associated with a fuel injection shot occurring during an engine cycle to determine a total amount of wear per engine cycle.

3. The combustion engine system of claim 2, wherein accounting for wear associated with the fuel injection shot comprises using a wear factor map, a pressure under which the fuel injection shot was performed, and a volume of fuel delivered during the fuel injection shot to determine a wear factor.

4. The combustion engine system of claim 3, wherein the fuel injection shot comprises two or more shots and the electronic control module is configured to sum wear factors attributable to each of the two or more shots to determine the total amount of wear per engine cycle.

5. The combustion engine system of claim 2, wherein the electronic control module is further configured for capturing the total amount of wear per engine cycle at a sample rate.

6. The combustion engine system of claim 5, wherein the sample rate is the engine cycle rate or some interval thereof.

7. The combustion engine system of claim 5, wherein the sample rate is irrespective of engine speed.

8. The combustion engine system of claim 7, wherein the electronic control module is further configured for adjusting the total amount of wear per engine cycle to an amount of wear per sample based on the sample rate and the engine speed.

9. (canceled)

10. The combustion engine system of claim 1, wherein determining the compensation time comprises selecting a fuel delivery map based on a pressure in the common rail and receiving a fuel demand volume.

11-12. (canceled)

13. A method for compensating for fuel injector wear, comprising:
accumulating wear on the fuel injector as accumulated wear;
establishing a wear parameter based on the accumulated wear;
determining a compensation time to hold a fuel injector open to compensate for the accumulated wear by:
determining a first delivery time using a fuel injector delivery curve from a new fuel injector;
determining a second delivery time using a fuel injector delivery curve from a worn fuel injector; and
adjusting the first delivery time and the second delivery time based on the wear parameter to arrive at the compensation time; and
operating the fuel injector by opening the fuel injector for the compensation time.

14. The method of claim 13, further comprising accounting for wear associated with a fuel injection shot occurring during an engine cycle to determine a total amount of wear per engine cycle.

15. The method of claim 13, wherein accounting for wear associated with the fuel injection shot comprises using a wear factor map, a pressure under which the fuel injection shot was performed, and a volume of fuel delivered during the fuel injection shot to determine a wear factor.

16. The method of claim 15, wherein the fuel injection shot comprises two or more shots, the method further comprising summing wear factors attributable to each of the two or more shots to determine the total amount of wear per engine cycle.

17. The method of claim 14, further comprising:
capturing the total amount of wear per engine cycle at a sample rate that is irrespective of engine speed; and
adjusting the total amount of wear per engine cycle to an amount of wear per sample based on the sample rate and the engine speed.

18. (canceled)

19. The method of claim 18, wherein determining the compensation time comprises selecting a fuel delivery map based on a pressure in the common rail and receiving a fuel demand volume.

20. (canceled)
